(19) United States
(12) Patent Application Publication
(10) Pub. No.: US 2003/0021082 A1
(43) Pub. Date: Jan. 30, 2003

(54) Detachable wireless input device of notebook computer

(75) Inventors: Kun-Chen Lu, Taipei (TW); Chun-Yen Yeh, Taipei (TW); Shih-Hsuan Wang, Taipei (TW)

Correspondence Address: BACON & THOMAS, PLLC, 625 SLATERS LANE, FOURTH FLOOR, ALEXANDRIA, VA, 22314

(73) Assignee: Inventec Corporation, Taipei (TW)

(21) Appl. No.: 09/912,322

(22) Filed: Jul. 26, 2001

(51) Int. Cl. G06F 1/16

(52) U.S. Cl. 361/683; 361/680; 400/82; 400/693

(57) ABSTRACT

A notebook computer comprises a housing including an internal control unit, a recess on a top surface, and wireless receiving means electrically coupled to the control unit; and detachable input means received in the recess and including wireless transmission means which is enabled as the input means is detached from the housing for activating a radio frequency (RF) transmission from the wireless transmission means to the wireless receiving means while entering inputs through the input means.

### FIELD OF THE INVENTION

The present invention relates to notebook computers and more particularly to such a notebook computer with a detachable wireless input device.

### BACKGROUND OF THE INVENTION

Conventionally, notebook computers are advantageous for being portable. This enables a user to carry a notebook computer away from home. One disadvantage thereof is its price higher than that of desktop computer which in turn adversely affects its sale in the market. In response, notebook computer manufacturers endeavor to develop more compact slim notebook computers while having large size liquid crystal displays (LCDs) and competitive prices as compared to desktop computers. Hence, in practice now many people prefer to use notebook computer in replacement of desktop computer even when working at home.

It is also understood that input device (e.g., keyboard) is proximate screen. As such, it is required for user to work just in front of notebook computer. This is quite inconvenient in some cases. In contrast, input device of a desktop computer is coupled to the computer through a cable having a predetermined length. Hence, a desktop computer user may place the input device in any of convenient positions while working. Thus, it is desirable to provide a detachable wireless input device of notebook computer having the convenience of input device of a typical desktop computer while working.

### SUMMARY OF THE INVENTION

It is an object of the present invention to provide a notebook computer comprising a housing including an internal control unit, a recess on a top surface, and wireless receiving means electrically coupled to the control unit; and detachable input means received in the recess and including wireless transmission means which is enabled as the input means is detached from the housing for activating a radio frequency (RF) transmission from the wireless transmission means to the wireless receiving means while entering inputs through the input means. By utilizing this, the detached input means may be disposed in any of convenient positions while working as long as the signal transmission from wireless transmission means to wireless receiving means is not adversely affected.

In one aspect of the present invention, the housing further comprises a first signal connector on the recess electrically coupled to the control unit, and the input means further comprises a second signal connector disposed corresponding to the first signal connector. The first and the second signal connectors are coupled together as the input means is received in the recess. At this position, input means is used as a typical keyboard of notebook computer for inputting data into the computer via the control unit.

In another aspect of the present invention the housing further comprises an internal first chargeable power supply electrically coupled to the first signal connector, and the input means further comprises an internal second chargeable power supply electrically coupled to the second signal connector so that a power is supplied from the first power supply to the input means while the second power supply is charged by the first power supply as the input means is secured in the recess.

The above and other objects, features and advantages of the present invention will become apparent from the following detailed description taken with the accompanying drawings.

### BRIEF DESCRIPTION OF THE DRAWINGS

FIG. 1 is a perspective view of a notebook computer according to the invention where input device is separated from the computer; and

FIG. 2 is another perspective view of the FIG. 1 where input device is mounted on the computer.

### DETAILED DESCRIPTION OF THE PREFERRED EMBODIMENTS

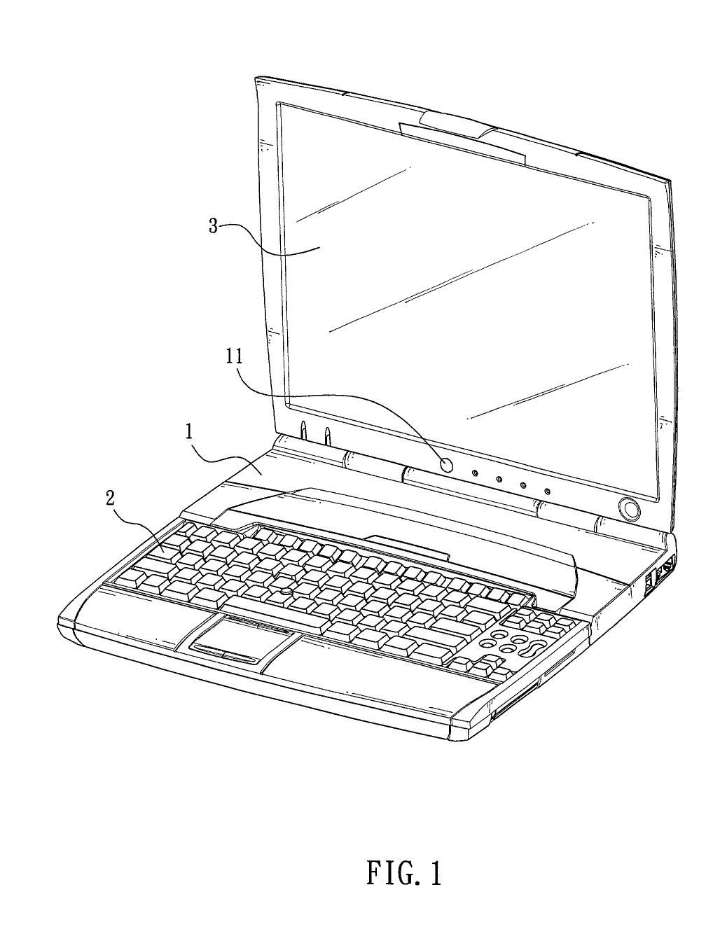

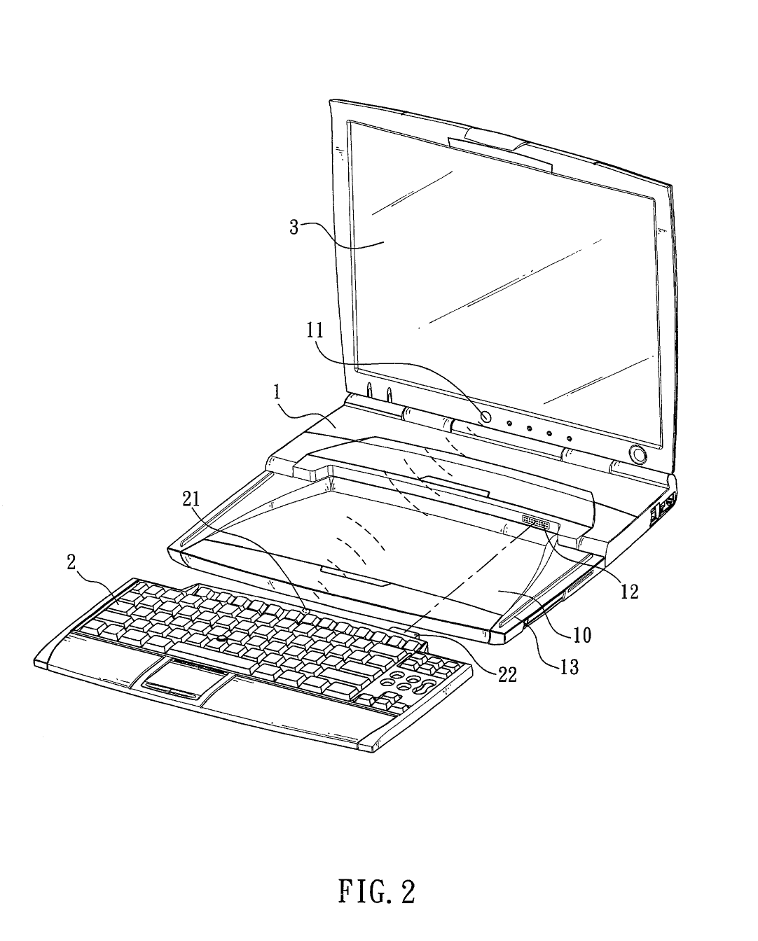

Referring to FIGS. 1 and 2, there is shown a notebook computer according to the invention. The notebook computer comprises a housing 1, an input device (e.g., keyboard) 2, and a screen 3 hingedly coupled to housing 1. The characteristics of the invention are detailed below.

The input device 2 is detachably coupled to housing 1. Housing I comprises a recess 10 on a top surface for receiving input device 2 and a wireless receiving device 11 near a hinge between housing 1 and screen 3. Wireless receiving device 11 is electrically coupled to a control unit (not shown) within housing 1. Correspondingly, input device 2 comprises a wireless transmission device 21 which is automatically enabled as input device 2 is detached from housing 1. Hence, a radio frequency (RF) transmission is carried out from wireless transmission device 21 to wireless receiving device 11. As a result, data input from input device 2 may send to control unit for processing. Each of wireless receiving device 11 and wireless transmission device 21 is one of bluetooth, wireless network module (e.g., IEEE 802.11 A or IEEE 802.11 B), and infrared transmission module (e.g., Infrared Data Association (IrDA)).

Referring to FIG. 2 specifically, housing 1 further comprises a first signal connector 12 on a wall of recess 10. The first signal connector 12 is electrically coupled to the control unit. Correspondingly, input device 2 further comprises a second signal connector 22 on a rear side. The first signal connector 12 and second signal connector 22 are coupled together as input device 2 is received in recess 10. At this position, input device 2 is used as a typical keyboard of notebook computer for inputting data into the computer via the control unit. First signal connector 12 is further electrically coupled to a first chargeable power supply (not shown) within housing 1. Also, second signal connector 22 is electrically coupled to a second chargeable power supply (not shown) within input device 2. Hence, a power may be supplied from the first chargeable power supply to the input device 2 which is electrically coupled to the computer as secured in the recess 10. At the same time, the second power supply is charged by the first power supply. Thus, a detached input device 2 may operate a predetermined period of time after has been sufficiently charged by the computer.

Housing 1 further comprises a pair of opposite straight first engagement members (e.g., magnetic rails in this embodiment) 13 near sides of recess 10. Correspondingly, input device 2 further comprises a pair of opposite straight second engagement members (e.g., magnetic rails in this embodiment) on the places corresponding to the first engagement members of the housing 1. After input device 2 is placed in recess 10, first and second engagement members are magnetically coupled together for securing input device 2 in recess 10.

In brief, a signal transmission from input device 2 to control unit of computer is effected in a wireless manner as compared to wire connection in the prior art. This can save the space of computer occupied by the conventional cable which is used for connecting the computer and the input device 2 when the later is detached. Further, a detached input device 2 may be disposed in any of convenient positions while working as long as the signal transmission from wireless transmission device 21 to wireless receiving device 11 is not adversely affected. In other words, a detached input device 2 is allowed to misalign with housing 1.

While the invention herein disclosed has been described by means of specific embodiments, numerous modifications and variations could be made thereto by those skilled in the art without departing from the scope of the invention set forth in the claims.

What is claimed is:

1. A notebook computer comprising:
a housing including an internal control unit, a recess on a top surface, and wireless receiving means electrically coupled to the control unit;
a screen hingedly coupled to the housing; and
detachable input means received in the recess and including wireless transmission means which is enabled as the input means is detached from the housing for activating a radio frequency (RF) transmission from the wireless transmission means to the wireless receiving means while entering inputs through the input means.

2. The notebook computer of claim 1, wherein the housing further comprises a first signal connector on the recess electrically coupled to the control unit, and the input means further comprises a second signal connector disposed corresponding to the first signal connector, the first and the second signal connectors being coupled together as the input means is received in the recess.

3. The notebook computer of claim 2, wherein the housing further comprises an internal first chargeable power supply for supplying power to the input means secured in the recess.

4. The notebook computer of claim 3, wherein the input means further comprises an internal second chargeable power supply which is charged by the first power supply as the input means is secured in the recess.

5. The notebook computer of claim 2, wherein the housing further comprises a pair of first engagement members, and the input means further comprises a pair of second engagement members which are coupled to the first engagement members for securing the mounted input means in the recess.

6. The notebook computer of claim 5, wherein the first engagement members are on opposite sides of the recess, and the second engagement members are on opposite sides of the input means corresponding to the first engagement members.

7. The notebook computer of claim 6, wherein each of the first and the second engagement members is a magnetic rail.

8. The notebook computer of claim 1, wherein each of the wireless receiving means and the wireless transmission means is a bluetooth.

9. The notebook computer of claim 1, wherein each of the wireless receiving means and the wireless transmission means is a wireless network module.

10. The notebook computer of claim 1, wherein each of the wireless receiving means and the wireless transmission means is an infrared transmission module.
